(19) United States
(12) Patent Application Publication
(10) Pub. No.: US 2024/0118827 A1
(43) Pub. Date: Apr. 11, 2024

(54) EMBEDDED STORAGE CHIP DATA STORAGE METHOD, EMBEDDED STORAGE CHIP, AND DATA STORAGE SYSTEM

(71) Applicant: AXD(ANXINDA) MEMORY TECHNOLOGY CO., LTD., SHENZHEN (CN)

(72) Inventors: XIULU LI, SHENZHEN (CN); JIANQUAN WU, SHENZHEN (CN); XIAOCONG ZHU, SHENZHEN (CN); SHANTENG YIN, SHENZHEN (CN)

(21) Appl. No.: 18/477,548

(22) Filed: Sep. 29, 2023

(30) Foreign Application Priority Data
Oct. 9, 2022 (CN) 202211223951.6

(51) Int. Cl. G06F 3/06

(52) U.S. Cl. CPC G06F 3/0655; G06F 3/0604; G06F 3/0673

(57) ABSTRACT

An embedded storage chip data storage method, an embedded storage chip, and a data storage system are provided. The embedded storage chip data storage method preferentially connects a first data storage channel and a host terminal, if the first data storage channel is connected to the host terminal, the first data storage channel specifies a first target storage area according to data information sent by the host terminal to store the data information sent by the host terminal; otherwise, a second data storage channel is connected to the host terminal, and the second data storage channel specifies a second target storage area according to the data information sent by host terminal to store the data information sent by the host terminal.

### TECHNICAL FIELD

The present disclosure relates to a technical field of data storage, and in particular to an embedded storage chip data storage method, an embedded storage chip, and a data storage system.

### BACKGROUND

Embedded storage chips are important data storage devices of electronic products, and reliability and stability of which become one of important consideration factors of manufacturers and users to choose.

In the related art, the embedded storage chips each is connected to a host terminal through a single firmware to perform data storage. Therefore, when use environment causes the single firmware to be damaged or when reliability of the single firmware is not ensured and the single firmware is damaged, a corresponding embedded storage chip needs to be detached and the single firmware is re-recorded into the corresponding embedded storage chip, such a process is tedious and high in cost, and the corresponding embedded storage chip is easily damaged to cause a risk of data loss.

Therefore, how to overcome the technical problems caused by data storage by connecting each of the embedded storage chips with a corresponding host terminal through the single firmware is a problem that those who skilled in the art needs to face.

### SUMMARY

The present disclosure provides an embedded storage chip data storage method, an embedded storage chip, and a data storage system for solving technical problems of tedious use, poor reliability, and high cost of embedded storage chips in the related art caused by connecting to a host terminal through a single firmware.

In a first aspect, one embodiment of the present disclosure provides an embedded storage chip data storage method, including:
performing data interaction, data identification, and data connection between a first data storage channel and a host terminal;
if the first data storage channel and the host terminal perform the data connection, specifying a first target storage area by the first data storage channel according to data information sent by the host terminal to store the data information sent by the host terminal;
otherwise, performing the data interaction, the data identification, and the data connection between a second data storage channel and the host terminal, and specifying a second target storage area by the second data storage channel according to the data information sent by the host terminal to store the data information sent by the host terminal.

The embedded storage chip data storage method of the present disclosure has at least followed beneficial effects.

The embedded storage chip data storage method of the present disclosure preferentially connects the first data storage channel and the host terminal, if the first data storage channel is connected to the host terminal, the first data storage channel specifies the first target storage area according to the data information sent by the host terminal to store the data information sent by the host terminal; otherwise, the second data storage channel is connected to the host terminal, and the second data storage channel specifies the second target storage area according to the data information sent by host terminal to store the data information sent by the host terminal. According to the embedded storage chip data storage method of the present disclosure, two firmwares are respectively arranged in the first data storage channel and the second data storage channel for being in data communication with the host terminal, which solves technical problems that poor reliability of the embedded storage chip is caused due to connecting the embedded storage chip to the host terminal through a single firmware, the single firmware is easy to be damaged causing high repair cost and data loss. Therefore, the embedded storage chip data storage method of the present disclosure is high in reliability and convenient to use.

Another embodiment of the embedded storage chip data storage method of the present disclosure further includes:
providing the first data storage channel including a main controller, a dual-mode dual-data rate (DDR) synchronous dynamic random access memory (SDRAM), and a DDR SDRAM controller for controlling the DDR SDRAM;
if the main controller and the host terminal perform the data interaction and the data identification, controlling the DDR SDRAM to perform netlist mapping and netlist refreshing by the DDR SDRAM controller according to the data information sent by the host terminal, and storing the data information sent by the host terminal in the first target storage area specified by the main controller.

Another embodiment of the embedded storage chip data storage method of the present disclosure further includes:
providing the second data storage channel including a standby controller, the DDR SDRAM controller, and the DDR SDRAM;
if the main controller and the host terminal fail to perform the data connection, controlling the DDR SDRAM to perform the netlist mapping and the netlist refreshing by the DDR SDRAM controller according to the data information sent by the host terminal, and storing the data information sent by the host terminal in the second target storage area specified by the standby controller.

Another embodiment of the embedded storage chip data storage method of the present disclosure further includes:
providing the main controller including a first flash controller, arranging the first target storage area in a flash storage array, and arranging a first control program for the flash storage array in the first flash controller;
when the first flash controller and the host terminal perform the data interaction and the data identification, controlling the DDR SDRAM to perform the netlist mapping and the netlist refreshing by the DDR SDRAM controller, and storing the data information sent by the host terminal in a first area of the flash storage array specified by the first flash controller.

Another embodiment of the embedded storage chip data storage method of the present disclosure further includes:
providing the standby controller including a second flash controller, arranging the second target storage area in the flash storage array, and arranging a second control program for the flash storage array in the second flash controller;
when the first flash controller and the host terminal fail to perform the data connection, controlling the DDR SDRAM to perform the netlist mapping and the netlist refreshing by the DDR SDRAM controller, and storing the data information sent by the host terminal in a second area of the flash storage array specified by the second flash controller.

According to another embodiment of the embedded storage chip data storage method of the present disclosure, the host terminal is a central processing unit (CPU).

In a second aspect, one embodiment of the present disclosure provides an embedded storage chip, including a first data storage channel and a second data storage channel. The first data storage channel is configured to connect to a host terminal and specify a first target storage area according to data information sent by the host terminal to store the data information sent by the host terminal. The second data storage channel is configured to connect to the host terminal and specify a second first target storage area according to data information sent by the host terminal to store the data information sent by the host terminal, when the first data storage channel fails to connect to the host terminal.

According to another embodiment of the embedded storage chip of the present disclosure, the first data storage channel includes a main controller, a dual-mode dual-data rate (DDR) synchronous dynamic random access memory (SDRAM), and a DDR SDRAM controller for controlling the DDR SDRAM. If the main controller and the host terminal perform data interaction and data identification, the DDR SDRAM controller controls the DDR SDRAM to perform netlist mapping and netlist refreshing according to the data information sent by the host terminal, and the data information sent by the host terminal is stored in the first target storage area specified by the main controller.

According to another embodiment of the embedded storage chip of the present disclosure, the second data storage channel includes a standby controller, the DDR SDRAM controller, and the DDR SDRAM. If the main controller and the host terminal fail to perform the data connection, the DDR SDRAM controller controls the DDR SDRAM to perform the netlist mapping and the netlist refreshing according to the data information sent by the host terminal, and the data information sent by the host terminal is stored in the second target storage area specified by the standby controller.

In a third aspect, one embodiment of the present disclosure provides a data storage system, including the host terminal and the embedded storage chip as foregoing. If the first data storage channel is connected to the host terminal, the first data storage channel specifies the first target storage area according to data information sent by the host terminal to store the data information sent by the host terminal; otherwise, the second data storage channel is connected to the host terminal, and the second data storage channel specifies the second target storage area according to the data information sent by the host terminal to store the data information sent by the host terminal.

### BRIEF DESCRIPTION OF DRAWINGS

FIG. 1 is a schematic flowchart of an embedded storage chip data storage method according to one embodiment of the present disclosure.

FIG. 2 is a schematic flowchart of the embedded storage chip data storage method according to another embodiment of the present disclosure.

FIG. 3 is a module diagram of an embedded storage chip according to one embodiment of the present disclosure.

FIG. 4 is a module diagram of the embedded storage chip according to another embodiment of the present disclosure.

FIG. 5 is a module diagram of the embedded storage chip according to another embodiment of the present disclosure.

FIG. 6 is a module diagram of a data storage system according to one embodiment of the present disclosure.

### DETAILED DESCRIPTION

Concepts and technical effects of the present disclosure are clearly and completely described below in connection with embodiments so as to fully understand objects, features, and effects of the present disclosure. Obviously, the described embodiments are only a part of the embodiments of the present disclosure rather than all embodiments, and based on the embodiments of the present disclosure, other embodiments obtained by those who skilled in the art without creative efforts shall fall within protection scopes of the present disclosure.

In the description of the embodiments of the present disclosure, if “several” is involved, the meaning thereof is more than one, and if “greater than”, “less than”, and “more than” are involved, it should be understood that the “greater than”, “less than” and “more than” should not include the present number, and should be understood as including the present number if “not less than”, “no greater than” and “no more than” are involved. If “first” and “second” are involved, it should be understood that the “first” and “second” should be understood as distinguishing technical features, and cannot be understood as indicating or implying relative importance or implicitly indicating the number of indicated technical features or implicitly indicating the sequential relationship of the indicated technical features.

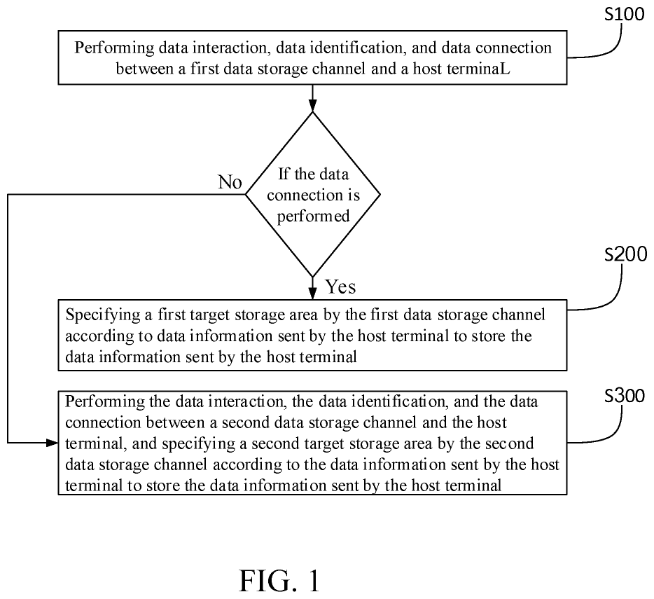

Referring to FIG. 1, one embodiment of the present disclosure provides an embedded storage chip data storage method, including following steps.

S100: performing data interaction, data identification, and data connection between a first data storage channel and a host terminal.

If the first data storage channel and the host terminal perform the data connection, then S200 is executed.

The S200: specifying a first target storage area by the first data storage channel according to data information sent by the host terminal to store the data information sent by the host terminal.

Otherwise, S300 is executed.

The S300: performing the data interaction, the data identification, and the data connection between a second data storage channel and the host terminal, and specifying a second target storage area by the second data storage channel according to the data information sent by the host terminal to store the data information sent by the host terminal.

In the present disclosure, the first data storage channel stores a control program that performs the data interaction and the data identification with the hist terminal and is capable of controlling the first target storage area, and the second data storage channel stores a control program that performs the data interaction and the data identification with the host terminal and is capable of controlling the second target storage area. When the host terminal sends the data information to an embedded storage chip, first, the data interaction and the data identification are performed between the first data storage channel and the host terminal, and if the first data storage channel and the host terminal perform the data connection, the first data storage channel determines a size of the data information according to the data information sent by the host terminal to specify the first target storage area adapted to the size of the data information for data storage. However, when the host terminal and the first data storage channel fail to perform the data connection, the host terminal actively performs the data interaction and the data identification with the second data storage channel, and after the host terminal and the second data storage channel perform the data connection, the second data storage channel determines the size of the data information according to the data information sent by the host terminal to specify the second target storage area that adapted to the size of the data information for the data storage. In the embodiment, both the first data storage channel and the second data storage channel are capable of performing the data interaction, the data identification, and the data connection with the host terminal. In the case that the first data storage channel and the host terminal fail to perform the data connection, the second data storage channel may perform the data connection with the host terminal and store the data information sent by the host terminal, thereby solving the technical problems in the related art that poor reliability of the embedded storage chip is caused due to connecting the embedded storage chip to the host terminal through a single firmware, and the single firmware is easy to be damaged causing high repair cost and data loss. Therefore, the embedded storage chip data storage method of the present disclosure is high in reliability and convenient to use.

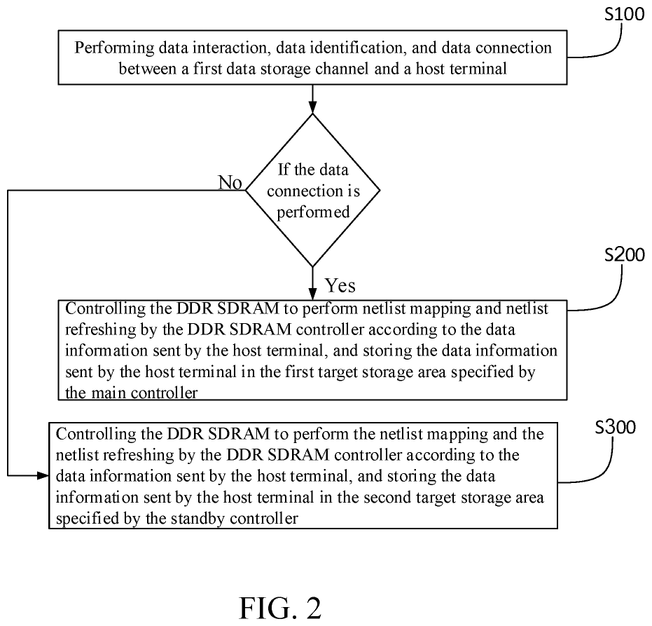

Referring to FIG. 2, in some embodiments, the first data storage channel includes a main controller, a dual-mode dual-data rate (DDR) synchronous dynamic random access memory (SDRAM), and a DDR SDRAM controller for controlling the DDR SDRAM. If the main controller and the host terminal perform the data interaction and the data identification, the DDR SDRAM controller controls the DDR SDRAM to perform netlist mapping and netlist refreshing according to the data information sent by the host terminal, and the data information sent by the host terminal is stored in the first target storage area specified by the main controller. In the embodiment, when the main controller is connected to the host terminal, the host terminal sends the data information to the main controller and the DDR SDRAM controller at the same time, the main controller specifies the first target storage area according to the data information sent by the host terminal, the DDR SDRAM controller controls the DDR SDRAM to perform the netlist mapping and the netlist refreshing according to the data information sent by the host terminal to store the data information sent by the host terminal in the first target storage area.

Referring to FIG. 2, in some embodiments, the second data storage channel includes a standby controller, the DDR SDRAM controller, and the DDR SDRAM. If the main controller and the host terminal fail to perform the data connection, the host terminal is connected to the standby controller, the DDR SDRAM controller controls the DDR SDRAM to perform the netlist mapping and the netlist refreshing, and the data information sent by the host terminal is stored in the second target storage area specified by the standby controller. In the embodiment, when the standby controller is connected to the host terminal, the host terminal sends the data information to the standby controller and the DDR SDRAM controller at the same time, the standby controller specifies the second target storage area according to the data information sent by the host terminal, the DDR SDRAM controller controls the DDR SDRAM to perform the netlist mapping and the netlist refreshing according to the data information sent by the host terminal to store the data information sent by the host terminal in the second target storage area.

In some embodiments, the first target storage area is arranged in a flash storage array, the main controller includes a first flash controller, and a first control program for the flash storage array is arranged in the first flash controller. When the first flash controller and the host terminal perform the data interaction and the data identification, the DDR SDRAM controller controls the DDR SDRAM to perform the netlist mapping and the netlist refreshing, and the data information sent by the host terminal is stored in a first area of the flash storage array specified by the first flash controller. In the embodiment, the flash storage array serves as a non-volatile storage device, which may stably store the data information sent by the host terminal.

In some embodiments, the second target storage area and the first target storage area are disposed in the same flash storage array, the standby controller includes a second flash controller, and a second control program for the flash storage array is arranged in the second flash controller. When the first flash controller and the host terminal fail to perform the data connection, the DDR SDRAM controller controls the DDR SDRAM to perform the netlist mapping and the netlist refreshing, and the data information sent by the host terminal is stored in a second area of the flash storage array specified by the second flash controller. In the embodiment, the second area of the flash storage array specified by the second flash controller and the first area of the flash storage array specified by the first flash controller in the above embodiment may be the same storage area or may be different storage areas, which may adapt to changes according to specific actual design requirements.

Furthermore, the host terminal includes a central processing unit (CPU), after the CPU terminal is connected to embedded storage chip through a connection interface, when the CPU sends data information to be stored to the embedded storage chip, the embedded storage chip preferentially connects to the CPU through the first data storage channel, and if the embedded storage chip is connected to the CPU, the first data storage channel specifies the first target storage area to store the data information to be stored sent by the CPU. If the first data storage channel fails to connected to the CPU, the CPU is connected to the second data storage channel, the second data storage channel specifies the second target storage area to store the data information to be stored sent by the CPU.

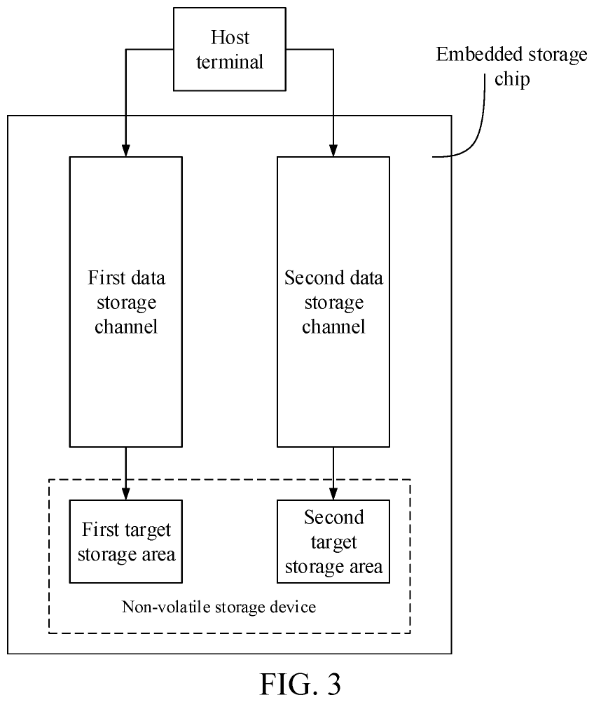

Referring to FIG. 3, the present disclosure further provides an embedded storage chip, including the first data storage channel and the second data storage channel. The first data storage channel is configured to connect to the host terminal and specify the first target storage area according to the data information sent by the host terminal to store the data information sent by the host terminal. The second data storage channel is configured to connect to the host terminal and specify the second first target storage area according to the data information sent by the host terminal to store the data information sent by the host terminal, when the first data storage channel fails to connect to the host terminal. In the embodiment, both the first target storage area and the second target storage area are disposed in the non-volatile storage device of the embedded storage chip. In the embodiment, both the first data storage channel and the second data storage channel are capable of performing the data interaction, the data identification, and the data connection with the host terminal. In the case that the first data storage channel and the host terminal fail to perform the data connection, the second data storage channel may perform the data connection with the host terminal and store the data information sent by the host terminal, thereby solving the technical problems in the related art that the poor reliability of the embedded storage chip is caused due to connecting the embedded storage chip to the host terminal through the single firmware, and the single firmware is easy to be damaged causing high repair cost and data loss.

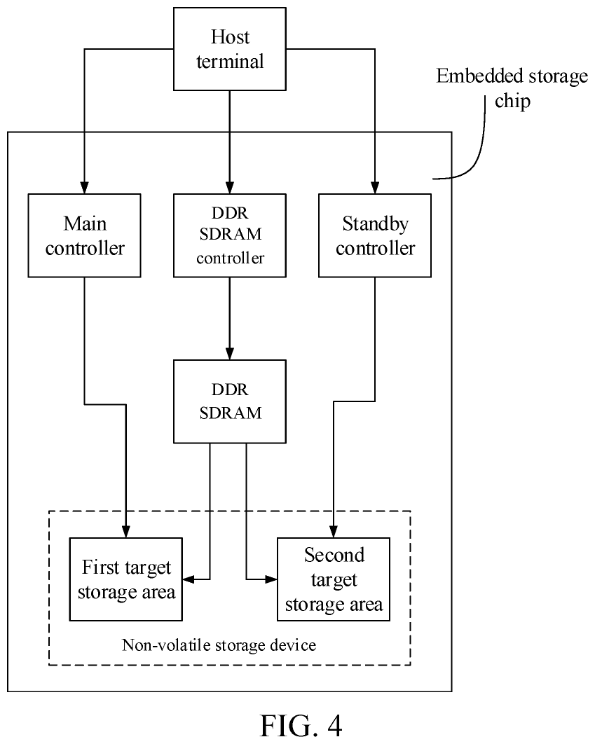

Referring to FIG. 4, in some embodiments, the first data storage channel includes the main controller, the dual-mode dual-data rate (DDR) synchronous dynamic random access memory (SDRAM), and the DDR SDRAM controller for controlling the DDR SDRAM. After the main controller and the host terminal perform the data interaction and the data identification, the host terminal respectively sends the data information to the main controller and the DDR SDRAM controller, the main controller specifies the first target storage area adapted to the data information sent by the host terminal according to the data information sent by the host terminal, the DDR SDRAM controller controls the DDR SDRAM to perform the netlist mapping and the netlist refreshing according to the data information sent by the host terminal, and the data information sent by the host terminal is stored in the first target storage area for data storage.

Referring to FIG. 4, in some embodiments, the second data storage channel includes the standby controller, the DDR SDRAM, and the DDR SDRAM controller for controlling the DDR SDRAM. After the main controller and the host terminal fail to perform the data connection, the host terminal is connected to the standby controller, at this time, the host terminal respectively sends the data information to the standby controller and the DDR SDRAM controller, the standby controllers specifies the second target storage area adapted to the data information sent by the host terminal according to the data information sent by the host terminal, the DDR SDRAM controller controls the DDR SDRAM to perform the netlist mapping and the netlist refreshing, and the data information sent by the host terminal is stored in the second target storage area for the data storage.

In some embodiment, the main controller is the first flash controller, the standby controller is the second flash controller, both the first target storage area and the second target storage area are disposed in the flash storage array. The first target storage area and the second target storage area may represent the same flash storage particles or different flash storage particles in the flash storage array. In the embodiment, the host terminal is the CPU, and a process of sending the data information to the embedded storage chip by the CPU refers to a data storage process of the embedded storage chip data storage method as foregoing. Details are not described herein.

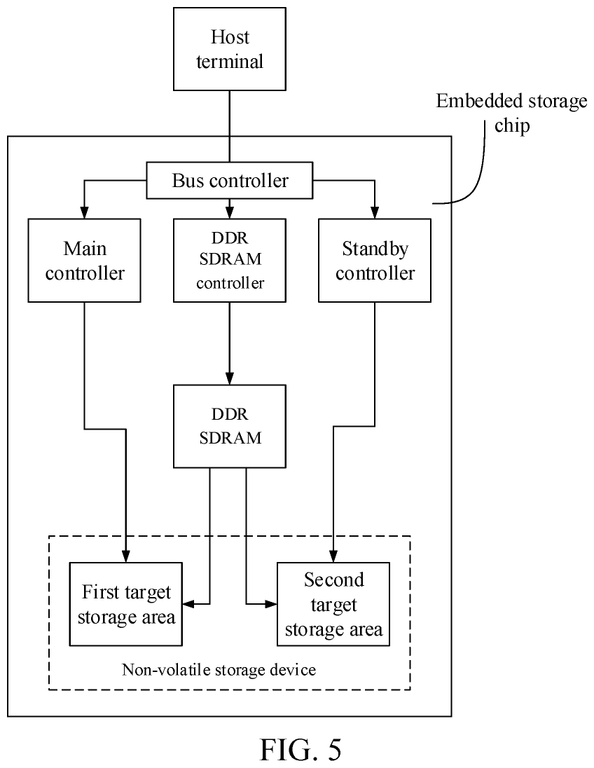

Referring to FIG. 5, in some embodiments, the embedded storage chip further includes a bus controller. The bus controller is connected to the first flash controller, the second flash controller, and the DDR SDRAM controller, respectively. One end of the bus controller is configured to be connected to the host terminal, such as the CPU.

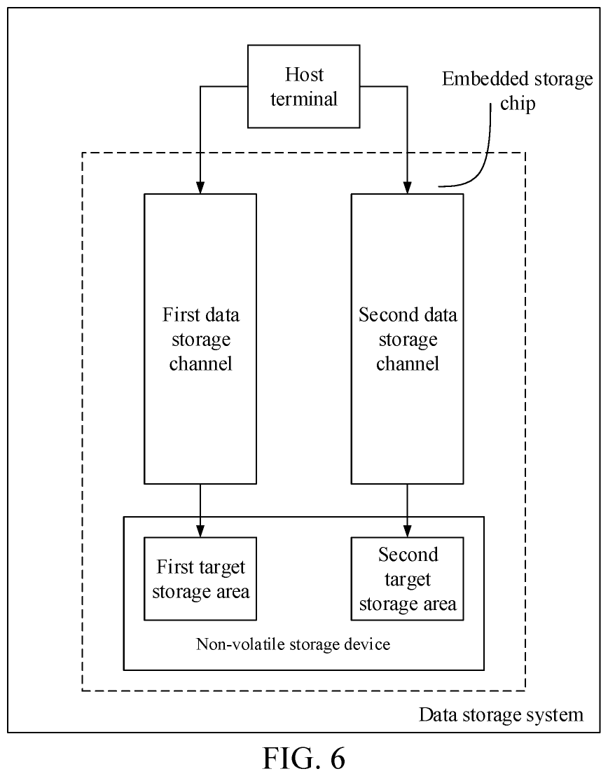

Referring to FIG. 6, one embodiment of the present disclosure provides a data storage system, including the host terminal and the embedded storage chip as foregoing. If the first data storage channel is connected to the host terminal, the first data storage channel specifies the first target storage area according to data information sent by the host terminal to store the data information sent by the host terminal; otherwise, the second data storage channel is connected to the host terminal, and the second data storage channel specifies the second target storage area according to the data information sent by the host terminal to store the data information sent by the host terminal.

In some embodiments, the host terminal is the CPU, the first data storage channel includes the main controller, the DDR SDRAM, and the DDR SDRAM controller for controlling the DDR SDRAM, the second data storage channel includes the standby controller, the DDR SDRAM, and the DDR SDRAM controller for controlling the DDR SDRAM. The main controller is the first flash controller, the standby controller is the second flash controller, both the first target storage area and the second target storage area are disposed in the flash storage array. When the CPU sends the data information to be stored to the embedded storage chip, and a data storage process of the embedded storage chip refers to a data storage process of the embedded storage chip data storage method as foregoing. Details are not described herein.

The embodiments of the present disclosure are described in detail above with reference to the accompanying drawings, but the present disclosure is not limited to the foregoing embodiments, and various changes may be made without departing from the spirit of the present disclosure within the scope of knowledge of those who skilled in the art. In addition, in the case of no conflict, the embodiments of the present disclosure and the features in the embodiments may be combined with each other.

What is claimed is:

1. An embedded storage chip data storage method, comprising:
performing data interaction, data identification, and data connection between a first data storage channel and a host terminal;
if the first data storage channel and the host terminal perform the data connection, specifying a first target storage area by the first data storage channel according to data information sent by the host terminal to store the data information sent by the host terminal;
otherwise, performing the data interaction, the data identification, and the data connection between a second data storage channel and the host terminal, and specifying a second target storage area by the second data storage channel according to the data information sent by the host terminal to store the data information sent by the host terminal;
providing the first data storage channel comprising a main controller, a dual-mode dual-data rate (DDR) synchronous dynamic random access memory (SDRAM), and a DDR SDRAM controller for controlling the DDR SDRAM;
if the main controller and the host terminal perform the data interaction and the data identification, controlling the DDR SDRAM to perform netlist mapping and netlist refreshing by the DDR SDRAM controller according to the data information sent by the host terminal, and storing the data information sent by the host terminal in the first target storage area specified by the main controller;
providing the second data storage channel comprising a standby controller, the DDR SDRAM controller, and the DDR SDRAM;
if the main controller and the host terminal fail to perform the data connection, controlling the DDR SDRAM to perform the netlist mapping and the netlist refreshing by the DDR SDRAM controller according to the data information sent by the host terminal, and storing the data information sent by the host terminal in the second target storage area specified by the standby controller;
providing the main controller comprising a first flash controller, arranging the first target storage area in a flash storage array, and arranging a first control program for the flash storage array in the first flash controller;
when the first flash controller and the host terminal perform the data interaction and the data identification, controlling the DDR SDRAM to perform the netlist mapping and the netlist refreshing by the DDR SDRAM controller, and storing the data information sent by the host terminal in a first area of the flash storage array specified by the first flash controller;
providing the standby controller comprising a second flash controller, arranging the second target storage area in the flash storage array, and arranging a second control program for the flash storage array in the second flash controller; and
when the first flash controller and the host terminal fail to perform the data connection, controlling the DDR SDRAM to perform the netlist mapping and the netlist refreshing by the DDR SDRAM controller, and storing the data information sent by the host terminal in a second area of the flash storage array specified by the second flash controller.

2. The embedded storage chip data storage method according to claim 1, wherein the host terminal is a central processing unit (CPU).

3. An embedded storage chip, comprising:
a first data storage channel, configured to connect to a host terminal and specify a first target storage area according to data information sent by the host terminal to store data information sent by the host terminal;
a second data storage channel, configured to connect to the host terminal and specify a second first target storage area according to data information sent by the host terminal to store the data information sent by the host terminal, when the first data storage channel fails to connect to the host terminal;
the first data storage channel comprises a main controller, a dual-mode dual-data rate (DDR) synchronous dynamic random access memory (SDRAM), and a DDR SDRAM controller for controlling the DDR SDRAM;
if the main controller and the host terminal perform data interaction and data identification, the DDR SDRAM controller controls the DDR SDRAM to perform netlist mapping and netlist refreshing according to the data information sent by the host terminal, and the data information sent by the host terminal is stored in the first target storage area specified by the main controller;
the second data storage channel comprises a standby controller, the DDR SDRAM controller, and the DDR SDRAM;
if the main controller and the host terminal fail to perform the data connection, the DDR SDRAM controller controls the DDR SDRAM to perform the netlist mapping and the netlist refreshing according to the data information sent by the host terminal, and the data information sent by the host terminal is stored in the second target storage area specified by the standby controller.

4. A data storage system, comprising:
the host terminal; and
the embedded storage chip according to claim 3;
wherein if the first data storage channel is connected to the host terminal, the first data storage channel specifies the first target storage area according to data information sent by the host terminal to store the data information sent by the host terminal;
otherwise, the second data storage channel is connected to the host terminal, and the second data storage channel specifies the second target storage area according to the data information sent by the host terminal to store the data information sent by the host terminal.
